(19) United States
(12) Patent Application Publication
(10) Pub. No.: US 2021/0304290 A1
(43) Pub. Date: Sep. 30, 2021

(54) Clothing Ordering and Delivery Service

(71) Applicant: Alyssa Kikalos, Chicago, IL (US)

(72) Inventor: Alyssa Kikalos, Chicago, IL (US)

(21) Appl. No.: 17/169,621

(22) Filed: Feb. 8, 2021

Related U.S. Application Data
(60) Provisional application No. 62/994,951, filed on Mar. 26, 2020.

(51) Int. Cl. G06Q 30/06; G06Q 10/08; G06Q 30/02; G06Q 20/12; H04W 4/021

(52) U.S. Cl. CPC G06Q 30/0639; G06Q 30/0633; G06Q 10/0835; H04W 4/021; G06Q 10/087; G06Q 20/12; G06Q 30/0282

(57) ABSTRACT

The present invention relates to a clothing ordering and delivery service that is comprised of a server and a software application designed to enable a customer to make an online clothing purchase and have the order delivered after the point of sale via a delivery agent within a twenty-four hour period. The software application/mobile application is further comprised of an easy to navigate interface to select nearby retailers within a geofence radius, search through the clothing inventory of the retailers, and place clothing orders. Further, the service allows a delivery agent to receive a customer order, retrieve the order from the retailer, and quickly deliver the order to the customer within several hours, and not longer than twenty-four hours.

### CROSS-REFERENCE TO RELATED APPLICATION

The present application claims priority to, and the benefit of, U.S. Provisional Application No. 62/994,951, which was filed on Mar. 26, 2020 and is incorporated herein by reference in its entirety.

### FIELD OF THE INVENTION

The present invention relates generally to the field of online clothing shopping. More specifically, the present invention relates to a clothing online ordering and delivery service that is comprised of a server and a software application designed to enable a customer to make an online clothing purchase and have the purchased clothing delivered within a twenty-four hour period. The software application/mobile application is comprised of an easy to navigate user interface that enables the user to select retailers within a predefined distance radius, search through the clothing inventory of the selected retailers, and place a clothing order with said retailer(s). Further, the service allows a delivery driver to receive the customer's order, retrieve the purchased items from the retailer, and deliver the purchased items to the customer, all within the twenty-four hour window. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

Individuals purchase clothing to fulfil their own needs, requirements, desires and preferences. Typically, individuals purchase clothing via in-store shopping or via a website. To purchase clothing via a physical in-store location, the individual is required to visit a brick and mortar store, navigate through large amounts of displayed clothing and other inventory to locate the desired clothing item(s) within the store, and then wait in a checkout line to purchase the item(s), all of which is both time-consuming and laborious. Additionally, certain stores of interest may be located too far away from an individual, and as such the individual may not be able to visit said store to buy clothes given the time constraints of their daily schedule. Moreover, certain individuals may lack adequate transportation to be able to travel to the desired store, which further prevents the individual from purchasing the clothing he or she desires.

One potential solution to the above referenced limitations associated with traditional brick and mortar clothing stores, is to shop online. While online shopping typically allows a user to more quickly locate desired clothing items, online shopping currently suffers from its own limitations. For example, while clothing items may be purchased from distantly located stores, it may take an undesirably long period of time for the purchased articles to arrive. These delays may not only be caused by the physical location of the store/distribution and its distance from the customer, but also due to administrative delays such as failure to stock items, shipping delays, etc. which may be exacerbated by excessive orders being placed (e.g., around the holidays or during a sale) and the lack of appropriate logistical support.

As such, delayed delivery of the ordered items may lead to unsatisfied customers. Further, customers who purchase clothing online for a specific occasion scheduled on a specific date may not receive their clothing before said date due to any number of the delays listed above. Additionally, online clothing stores lack the ability to give real-time or live updates and exact delivery times for order delivery other than an estimated date, which often leaves the customers confused and distressed as they may have a specific time window in which to receive the clothing for the specific event.

Therefore, there exists a long felt need in the art for a clothing ordering and delivery system and software application that provides a platform to customers to make online clothing purchases and have the purchases delivered within the same day (or twenty-four hour period), thereby eliminating the possibility of missing any events or occasions due to the failed delivery of the clothing in a timely manner. There is also a long felt need in the art for a clothing ordering and delivery service which enables a customer to order clothes online from nearby clothing stores and track the shipment of the clothes via live updates including the exact delivery time and location of the ordered item. Moreover, there is a long felt need in the art for a clothing delivery service which supports secure digital payment gateways, and that enables the customer to securely pay for the purchased items. Finally, there is a long felt need in the art for a clothing ordering and delivery system and software application that is both easy and safe to use.

The subject matter disclosed and claimed herein, in one embodiment thereof, comprises a clothing delivery service and method that utilizes a server and a smartphone/smart device/software application to allow a customer to purchase at least one clothing item from a nearby retailer and have the item delivered within only a few hours (or at most, twenty-four hours) from when the purchase was confirmed. The method comprises the initial steps of selecting a distance/time radius with respect to the current location of the user, and then selecting a retailer from a displayed list of retail stores within the selected radius. The customer may then select one or more clothing/fashion items, and purchase said items over the application using a digital payment means. Once payment has been made, the customer may then track the delivery status (e.g. GPS location and estimated arrival time) of the purchased product in real-time, wherein the clothing may be delivered by a delivery agent that is employed/contracted by the store, or who may be an independent contractor.

In this manner, the clothing delivery service and method of the present invention accomplishes all of the forgoing objectives, and provides a relatively easy and convenient means for an individual to order clothing online from nearby retailers, wherein the clothing may be delivered within the same day of ordering and wherein the location and estimated delivery time of the clothing can be tracked in real-time. The clothing delivery service and method of the present invention is also user friendly, as the software application/mobile application is easy to navigate and has a plurality of different features such as secure digital payments, nearby store selection, real-time order tracking and live delivery updates and estimated delivery times.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a clothing delivery system. The system is comprised of a mobile application/software and a server that allows a customer to order clothing or fashion items from nearby retailers via a distance-based radius search. The customer may then pay the retailer for the clothing/fashion items via a plurality of different digital payment means. Upon confirmation of payment, the system may then assign an independent delivery agent to pick up the order from a retailer and deliver the order to a customer within a specific amount of time, which is no longer than twenty-four hours. The customer may then use the mobile application to receive real-time updates on the location and estimated delivery time of the order, as well as physically communicate with the delivery agent via a phone call or text message. Similarly, the retailer may be able to use the system to receive real-time updates on the location and estimated delivery time of the agent/order, as well as physically communicate with the agent via a phone call or text message.

In another embodiment of the present invention, a method to allow a customer to purchase clothing/fashion items via a smartphone application is disclosed. The method comprises the initial steps of a customer creating a user profile within the system, and then signing in to the system/mobile application. The customer may then select a distance/time radius in order to appropriately choose nearby retailers for same day delivery using the GPS location of the customer's device that is in communication with the mobile application/system. A retailer is then selected by the customer, wherein the customer then browses the inventory of the selected retailer within the application to select at least one clothing/fashion item for purchase. The customer then completes a secure digital payment for the selected item(s), and receives information regarding the delivery agent who will deliver the order to the customer. The customer may then track the delivery status and GPS location of the delivery agent in real time via the mobile application. Finally, the customer receives delivery of their purchased item from the delivery agent within the same twenty-four hour ordering period, and may provide feedback on the retailer and/or delivery agent.

In yet a further embodiment of the present invention, a method to allow a delivery agent to collect a purchased clothing/item order from a retailer and deliver the order to a customer within twenty-four hours of purchase is disclosed. The method utilizes a server that assigns a purchase made by a customer to a particular delivery agent based on their current GPS location, or at the discretion of the server. The delivery agent then receives a notification or the customer's order, the delivery address of the customer and the address of the store from which the purchase was made. After receiving the details, the delivery agent then travels to the store, retrieves the order and delivers the order to the customer's address. Additionally, the delivery agent may inform the customer on the status, location, and estimated time of the delivery via a phone call or text message.

In yet another embodiment of the present invention, a system for delivering a purchased clothing item within a few hours, but no longer than 24 hours, from the time of its purchase is disclosed. The system comprises a server configured and connected to a processor that is capable of receiving and processing a request from a mobile application to purchase a clothing item, authorizing an electronic payment made by a customer for the purchased item, sending the purchase request to a retail store and a delivery request to an independent delivery driver for delivery of the purchased item to the customer who made the purchase within the same day.

The smartphone application or mobile application of the present invention features an easy to navigate interface that allows customers to select stores within a distance radius, search through available clothing items, and place orders for the same. The application has an integrated secure payment gateway, and allows an independent delivery driver to receive an order, retrieve the items from the store, and quickly deliver them to the customer within a couple hours, but within 24 hours at the most. Further, during the entire delivery process, the system provides the customer with real time updates on the location of the purchased items and the scheduled delivery time.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a simplified block diagram of one potential embodiment of the clothing ordering and delivery system of the present invention in accordance with the disclosed architecture;

FIG. 2 illustrates a representative view of the geofence selected by a customer using a smartphone application/software of the clothing ordering and delivery system of the present invention to view a graphical representation of participating nearby retailers within the geofence in accordance with the disclosed architecture;

FIG. 3 illustrates a flow diagram of the essential steps of one potential embodiment of the method of using the clothing ordering and delivery system of the present invention to purchase clothing for same day delivery in accordance with the disclosed architecture;

FIG. 4 illustrates a flow diagram of the essential steps of one potential embodiment of the method of a delivery agent using the clothing ordering and delivery system to deliver the order to the customer who made the purchase within 24 hours of the purchase and in accordance with the disclosed architecture; and

FIG. 5 illustrates a flow diagram of the essential steps of one potential embodiment of the method of using the clothing ordering and delivery system of the present invention to purchase clothing for same day delivery in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a clothing ordering and delivery system that provides a platform to customers to make online clothing purchases and have the purchases delivered within the same day (or twenty-four hour period). There is also a long felt need in the art for a clothing ordering and delivery service that enables a customer to order clothes online from nearby clothing stores, and track the shipment of the clothes via live updates including the exact delivery time and location of the ordered item. Moreover, there is a long felt need in the art for a clothing delivery service that supports secure digital payment gateways, and that enables the customer to securely pay for the purchased items with minimal effort.

The present invention, in one exemplary embodiment, is comprised of a system to order and deliver clothing and other fashion items to a customer within a twenty-four hour period. The system is comprised of a mobile application that contacts a server which allows a customer to browse the physical inventory of a nearby merchant/retailer within a specific distance/time radius from the customer's location. The customer may then order clothing/fashion related items from the retailer via the mobile application and system, wherein the customer will receive the items within the twenty-four hour period after being delivered by an independent delivery agent. The customer may further be able to track the delivery of their items in real-time via a GPS tracking feature that is part of the mobile application. Further, the delivery agent who delivers the order may call the customer to inform them of their estimated delivery time while in route to deliver the order.

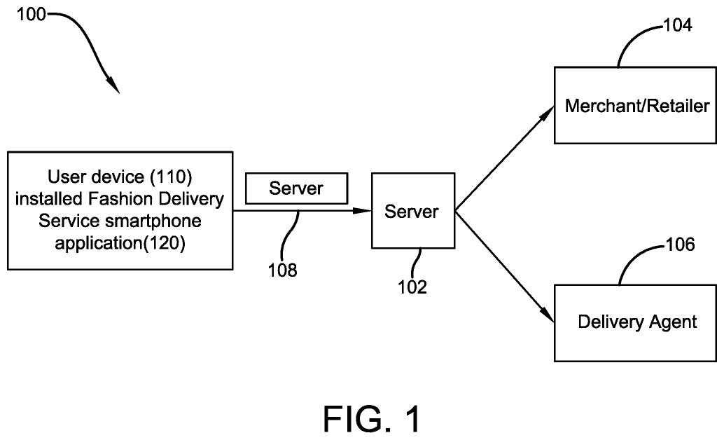

Referring initially to the drawings, FIG. 1 illustrates a simplified block diagram of one potential embodiment of the clothing ordering and delivery system 100 of the present invention in accordance with the disclosed architecture. The system 100 is preferably comprised of a processing server 102, at least one merchant/retailer 104, a delivery agent 106, an internet connection 108, a user device 110 and a software/mobile application 120. In differing embodiments of the system 100, the user device 110 may be a smart device such as, but not limited to, a smart phone, tablet, laptop, smart watch, computer, or any other internet/cellular capable devices of the like which can run a mobile application 120.

In use, a customer will use his or her device 110 to connect to a server 102 via an internet connection 108 (e.g., Bluetooth) to create a user profile that includes personal information about the user, such as name, address, clothing-type preferences, clothing size, etc. However, in a differing embodiment of the system 100, the user may access the server 102 via a cellular connection (e.g., 3G/4G/LTE/5G) or a satellite connection through the internet 108 via the mobile application 120. The server 102 then allows the smartphone/smart device application 120 to access an online representation of the physical (e.g. in-store) inventory of at least one nearby merchant/retailer 104 that sells clothing and other fashion accessories/items. Further, the server 102 is preferably comprised of a plurality of databases that store the physical location of the participating retailers 104, accurate retailer 104 inventory, and delivery agent 106 personal information such as name, driver's license, etc.

Once a customer has selected the clothing or fashion items that he or she desires to purchase from the retailer 104, the purchase may be completed via a plurality of digital payment options 404 such as, but not limited to, a credit card, debit card, PayPal, Venmo, Cashapp, Bitcoin, or any other digital wallet/payment service or similar prepaid payment mechanism. The server 102 then notifies the retailer 104 of a customer purchase and simultaneously assigns a delivery agent 106, who is geographically near the retailer 104 at the time, to deliver the purchase. In differing embodiments of the system 100, the delivery agent 106 may be an employee of the merchant 104, or may be a freelance independent contractor, wherein the agent 106 may use the mobile application 120 to fulfill delivery requests within the system 100 from retailers 104 in the same geographic area. To complete the delivery, the retailer 104 preferably provides the agent 106 with the details of the customer purchase, the retailer 104 pickup and the customer drop off addresses, and the time of the order/delivery in addition to the time requirements for when the order must be delivered via the mobile application 120 (e.g. within twenty-four hours).

More specifically, when the server 102 receives an authorized purchase of clothing or another fashion item notification from the retailer 104, the independent delivery agent 106 may then be selected based on their current proximity to the retailer 104 via the GPS location of the mobile device 110 that is in communication with the server 102. Nonetheless, the current location of the user device 110 may also be detected by other means, such as a Wi-Fi signal sensor, an IP address, one or more cellular phone towers, a radio frequency identifier (RFID) transponder, a wireless proximity beacon, latitude and longitude, etc.

In an alternative embodiment of the present invention, the system 100 may be comprised of a means for a plurality of agents 106 to bid against one another to secure the rights to a particular delivery and/or the agent 106 may be compensated for the delivery based on the distance, time, and/or clothing/item quantity required for the delivery. Similarly, the system 100 may also charge the customer a premium fee within the mobile application 120 for expedited delivery or other specialized delivery requirements. The chosen delivery agent 106 is then able to pick up and deliver a purchased item/order to a customer within several of hours of completion of the purchase, but not later than twenty-four hours after the purchase.

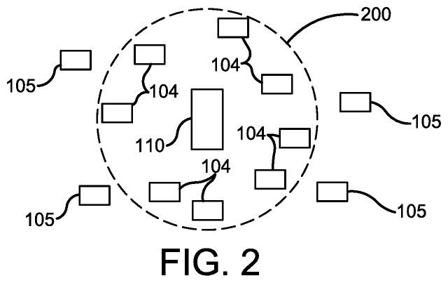

FIG. 2 illustrates a representative view of the geofence 200 selected by a customer using a smartphone application/software of the clothing ordering and delivery system 100 of the present invention to view a graphical representation of participating nearby retailers 104 within the geofence 200 in accordance with the disclosed architecture. More specifically, the geofence 200 can be selected by a customer within the mobile application 120, wherein the fence 200 automatically identifies any participating physical retailer 104 location within, for example, a 15-mile radius from the current location of the user device 110, and further wherein the current location of the user device 110 may be detected by a Wi-Fi signal sensor, GPS coordinates, IP address, one or more cellular phone towers, a radio frequency identifier transponder, a wireless proximity beacon, latitude and longitude, etc.

In alternative embodiments of the system 100, the geofence 200 radius distance may be set by the customer to any custom radial distance in miles, kilometers, or minutes/hours away. As such, the retailers 104 within the geofence 200 may be displayed within the mobile application 120 via a graphical representation that may be superimposed over an interactive satellite map. Any retailers 105 which are outside the geofence 200 location may be displayed as outside of the geofence 200 in the graphical representation within the application 120 (so that the user is at least aware of the presence of the same in case, for example, the user wants to expand the radius), or may not be displayed at all. Further, the mobile application 120 may automatically impose or suggest a radius limit on the geofence 200 distance to ensure that same day delivery remains possible based on the user's location in relation to the retailer 104, the availability and distance of any delivery agents 106 from the retailer 104, and the customer's distance from any given agent 106.

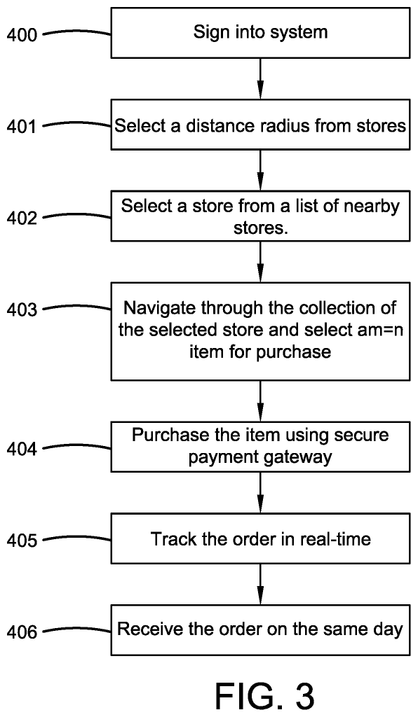

FIG. 3 illustrates a flow diagram of the essential steps of one potential embodiment of the method of using the clothing ordering and delivery system 100 of the present invention to purchase clothing for same day delivery in accordance with the disclosed architecture. For example, at step 400 the customer will first create or log into an existing profile on the smartphone application 120. The profile may include information about the customer such as, but not limited to, the customer's name, delivery address, age, type/style of clothes the customer is primarily interested in, clothing size, etc. to further recommend clothing/items to the customer via an algorithm that may be part of the application 120 and/or server 102. After the customer successfully creates the account or otherwise logs into an existing account, the customer may then select a distance/time radius to view and browse retailers 104 located within the geofence 200 at step 401. As noted above, the GPS location of the user's device 110 used to browse the application 120 and access the system 100 may be used to select the radius based on the current location of the user device 110 in relation to the plurality of retailers 104 and/or delivery agents 106. Once a list of relevant retailers 104 is shown to the customer, wherein the retailers 104 may be further filtered by the customer based on such criteria as brands, price, clothing style, etc., the customer may choose the particular retailer(s)104 that he or she is interested in at step 402.

After selecting the retailer(s) 104, the customer navigates through the clothing/fashion item inventory of the selected retailer 104 and selects one or more items for purchase at step 403. Alternatively, based on the selection of a particular type of item (e.g. style or type of clothing) a retailer 104 may be automatically selected by an algorithm within the system 100 and suggested to a customer, or the system may display the same item available from a plurality of retailers 104 and let the customer decide from whom to purchase the item (e.g., based on, for example, one or more factors such as price, return policy, customer service, etc.). At step 404, the customer may then complete the purchase of the selected item by making an authorized payment to the retailer 104 via a secure digital payment gateway included as part of the smartphone application 120 such as a credit card, debit card, PayPal, Venmo, Cashapp, Bitcoin, or any other digital wallet/payment service or similar prepaid payment mechanism. The customer then receives a confirmation of the order with an estimated time of delivery, and also receives information regarding the independent delivery agent 106 assigned to deliver the order.

At step 405, the customer may then track the delivery status and GPS location of the agent 106 in real time within the smartphone application, in addition to receiving a plurality of location and time updates from the delivery agent 106 by virtue of text, phone call, email, etc. Finally, at step 406, the customer receives the order from the delivery agent 106 within the same day or twenty-four hour period. In a further embodiment of the system 100, the customer may select a time slot for receiving the delivery via the application 120 (e.g. within a particular amount of hours from purchase, or, for example, between the hours of 4 and 6 pm). Further, the mobile application 120 can also be used to provide feedback on the quality of the product and/or the delivery service. The customer can also leave a review regarding the overall system 100 experience, and/or may give a tip to the delivery agent 106 using the application 120.

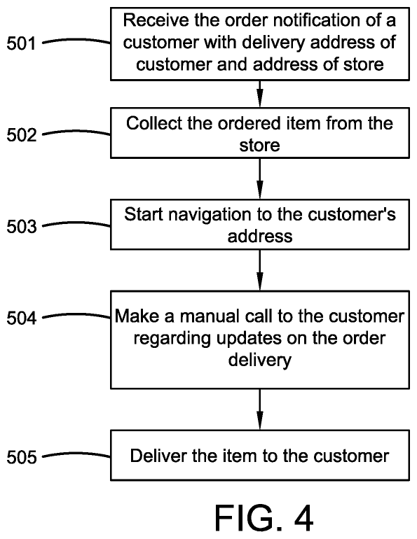

FIG. 4 illustrates a flow diagram of the essential steps of one potential embodiment of the method of a delivery agent 106 using the clothing ordering and delivery system 100 to deliver the ordered product to the customer who made the purchase within 24 hours of the purchase and in accordance with the disclosed architecture. As noted above, the server 102 of the system 100 assigns a purchase made by a customer to a delivery agent 106 to deliver the purchased item(s) within twenty-four hours of the purchase. The delivery agent 106 may be selected/assigned based on their current GPS location and the location of the store 104 from which the purchase is made by a customer via the server 102. At step 501, the selected delivery agent 106 first receives an order notification of a customer along with the delivery address of the customer and the address of the store from which the purchase was made via the server 102. After receiving the order details, the driver 106 travels to the retailer 104 and collects the ordered item(s) from the retailer 106 at step 502. After collecting the ordered items from the retailer 104, the delivery agent 106 navigates to the customer's address in step 503, while also taking the optional step of making a phone call or sending a text message or email to the customer regarding the status of the delivery (e.g. estimated time of arrival and current location) at step 504. Finally, at step 505, the delivery agent 106 reaches the address of the customer and delivers the order to the customer, wherein the agent 106 may further update the delivery status on the driver version of the smartphone application 120.

It should also be noted that the customer may receive automatic notifications of each step of the shipment and delivery of the order, such as when the delivery agent 106 picks up the item(s) from a retailer 104, and when the agent 106 is in route to the customer. Further, a customer may contact the delivery agent 106 via a phone call or text message. Similarly, in one embodiment of the system 100, the retailer 104 may also receive automatic notifications of each step of the shipment and delivery of the order, such as when the independent delivery agent 106 delivers the purchased item(s) to the customer, and when the order has been assigned to a delivery agent 106. In addition, the retailer 104 may also be able to contact the agent 106 via a text message or phone call. In yet another embodiment of the system 100, a time limit may also be assigned to a delivery agent 106 for delivering the assigned order to the customer, and a bonus (monetary or non-monetary) may be given to the independent delivery agent 106 for delivering the item(s) before the time limit.

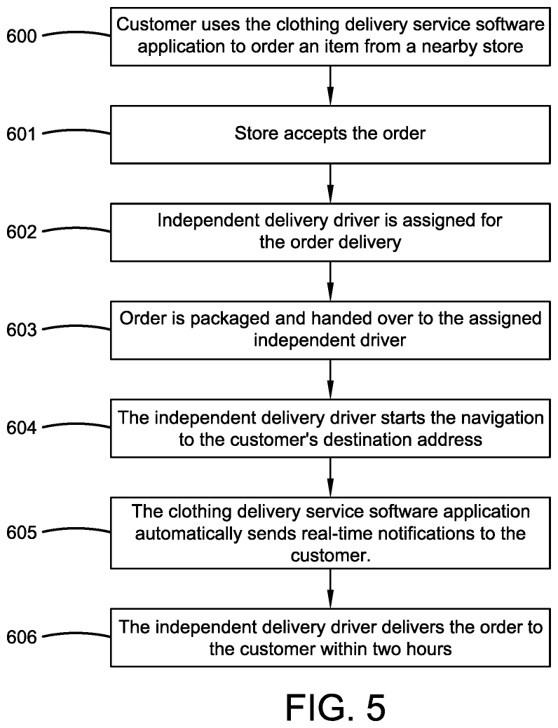

FIG. 5 illustrates a flow diagram of the essential steps of one potential embodiment of the method of using the clothing ordering and delivery system of the present invention to purchase clothing for same day delivery in accordance with the disclosed architecture. More specifically, at step 600, the customer uses the mobile application 120 to order an item or items from a nearby retailer 104, which is located within a radius set by the customer or the application 120. At step 601, the retailer 104 accepts the accepts the customer's order, and the system 100 then assigns a delivery agent 106 for delivery of the order at step 602. The ordered item is then packaged and given to the assigned independent delivery agent 106 by the retailer 104 to make the delivery at step 603. After picking up the item(s), the delivery agent 106 starts the navigation to the customer's address at step 604, and the system 100 and/or application 120 further automatically sends real-time notifications and GPS location updates to the customer and retailer 104 regarding the location of the delivery agent and order at step 605. Finally, at step 606, the delivery agent 106 delivers the order to the customer within a designated time limit, such as two-hours.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “clothing delivery service”, “clothing delivery system”, and “system” are interchangeable and refer to the clothing ordering and delivery service 100 of the present invention.

Notwithstanding the forgoing, the clothing ordering delivery service 100 of the present invention can be comprised of an additional software and/or hardware configuration as is known in the art without affecting the overall concept of the invention, provided that it accomplishes the above stated objectives. The clothing ordering and delivery system and software application may be practiced using any network including, without limitation, computing grid systems, distributed computing environments, cloud computing environments, and the like.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A clothing ordering and delivery system comprising:
a user device having a mobile application installed thereon;
a server;
a retail location having an inventory of products for sale;
a delivery agent; and
a geofence.

2. The clothing ordering and delivery service of claim 1, wherein the geofence if a user specified radius around a location of the user device.

3. The clothing ordering and delivery service of claim 2, wherein the retail location is located within the geofence.

4. The clothing ordering and delivery service of claim 1, wherein each of the user device, the server, the retail location and the delivery agent are in wireless communication with each other.

5. The clothing ordering and delivery service of claim 1, wherein at least one of the inventory of products for sale is delivered to a user within 24 hours of a purchase.

6. The clothing ordering and delivery service of claim 1, wherein the inventory of products for sale comprises a plurality of clothing items.

7. A method of remotely ordering clothing for delivery within a 24 hour period, wherein the method comprises the steps of:
creating or logging into a customer account with a user device;
establishing a geofence;
selecting at least one retail store having an inventory of clothing products;
selecting at least one product from the inventory of clothing products;
purchasing the at least one product;
tracking a location of the at least one product prior to its delivery; and
receiving the at least one product prior to its delivery.

8. The method of remotely ordering clothing for delivery within a 24 hour period of claim 7, wherein the geofence if a user specified radius around a location of the user device.

9. The method of remotely ordering clothing for delivery within a 24 hour period of claim 8, wherein the at least one retail store is located within the geofence.

10. The method of remotely ordering clothing for delivery within a 24 hour period of claim 7, wherein each of the user device, the at least one retail store and a delivery agent are in wireless communication with each other.

11. The method of remotely ordering clothing for delivery within a 24 hour period of claim 7 further comprising the step of comparing a price of the at least one product at a plurality of retail stores prior to the step of purchasing the at least one product.

12. The method of remotely ordering clothing for delivery within a 24 hour period of claim 7 further comprising the step of instructing a delivery agent to deliver the at least one product after the step of purchasing the at least one product.

13. The method of remotely ordering clothing for delivery within a 24 hour period of claim 7 further comprising the step of providing a review of the at least one retail store where the purchase was made.

14. A method of remotely fulfilling a clothing order, wherein the method comprises the steps of:
advertising a plurality of clothing articles on a platform in communication with a customer's electronic device;
receiving an order for at least one of the plurality of clothing articles from the customer located within a geofence;
retrieving the at least one of the plurality of clothing articles from an inventory;
processing the customer's payment for the at least one of the plurality of clothing articles;
providing the customer with at least one electronic notification of a status of the delivery of the at least one of the plurality of clothing articles; and
instructing a delivery agent to deliver the at least one of the plurality of clothing articles to the customer.

15. The method of remotely fulfilling a clothing order of claim 14, wherein the geofence is a customer specified radius around a location of the customer.

16. The method of remotely fulfilling a clothing order of claim 14 further comprising the step of receiving a review from the customer.

17. The method of remotely fulfilling a clothing order of claim 14, wherein the delivery agent is in wireless communication with the customer's electronic device.

18. The method of remotely fulfilling a clothing order of claim 14 further comprising the step of providing a secure payment gateway to the customer.

19. The method of remotely fulfilling a clothing order of claim 14 further comprising the step of selecting the delivery agent based on the delivery agent's proximity to the inventory.

20. The method of remotely fulfilling a clothing order of claim 14 further comprising the step of rewarding the delivery agent for an on tim delivery of the at least one of the plurality of clothing articles to the customer.
